(19) United States
(12) Patent Application Publication
(10) Pub. No.: US 2026/0074602 A1
(43) Pub. Date: Mar. 12, 2026

(54) CONVERTER FOR SUPPLYING POWER TO A POWER STORAGE SYSTEM

(71) Applicant: Gary M. Charlesworth, Jacksonville, FL (US)

(72) Inventor: Gary M. Charlesworth, Jacksonville, FL (US)

(21) Appl. No.: 19/336,392

(22) Filed: Sep. 22, 2025

Related U.S. Application Data
(60) Provisional application No. 63/692,282, filed on Sep. 9, 2024.

(51) Int. Cl. H02M 1/00; H02J 7/00; H02J 7/35; H02M 3/00; H02M 3/158; H02M 3/335

(52) U.S. Cl. CPC H02M 1/0006; H02J 7/35; H02J 7/855; H02M 3/003; H02M 3/1582; H02M 3/33584; H02J 2101/25; H02J 2207/20

(57) ABSTRACT

A converter allows a portable power storage system to be charged from an external DC power source, such as a vehicle's DC power outlet. The converter contains a DC-to-DC power circuit within a housing. This circuit receives a lower DC voltage from the external source and boosts it to a higher, regulated output voltage. A first connector links to the external source while a second connector, such as an MC4 or Anderson Powerpole, mates with the power storage system's solar panel inlet. The converter's output voltage and current are regulated to emulate a solar panel array's power-voltage characteristics, enabling the power storage system's existing charging circuitry to function without modification. The device may be bidirectional, allowing power to flow back to the vehicle for tasks like jump-starting. The system enhances versatility of portable power storage units by enabling charging from diverse DC sources when solar power isn't available.

### FIELD OF THE INVENTION

This invention relates generally to power storage systems, and, more particularly, to a converter that connects a vehicle to a power storage system and transforms DC power from the vehicle outlet to emulate supply voltage from a solar array.

### BACKGROUND OF THE INVENTION

Portable power storage systems, also referred to as portable power stations or battery packs, are compact and versatile devices designed to provide both direct current (DC) and alternating current (AC) power outputs. Such systems are widely used to operate equipment, small appliances, and electronic devices in environments where access to the electrical grid is limited or unavailable.

Modern portable power storage systems commonly employ lithium-ion or lithium iron phosphate batteries due to their favorable characteristics, including high energy density, long cycle life, and reduced weight compared to traditional lead-acid batteries. The capacity of these systems, measured in watt-hours (Wh), determines the total amount of stored energy available for use, with higher capacities enabling extended operation of connected loads.

To regulate power delivery, many systems include internal DC-DC converters that provide stable voltage outputs suitable for devices requiring DC input, such as USB-powered electronics or 12-volt appliances. Charging circuits are further provided to manage energy supplied to the batteries, ensuring safe and efficient charging without risk of overcharging or damage. The specific charging circuitry is often selected based on the nature of the supply source.

For example, when solar panels are employed, a Maximum Power Point Tracking (MPPT) controller may be utilized. The output voltage and current of a solar panel vary with environmental conditions such as sunlight intensity and temperature. The MPPT controller identifies and operates the panel at its maximum power point, converting the higher and variable DC voltage of the panel to a lower, stable voltage appropriate for charging the system batteries. For effective performance, the DC input supplied to the MPPT controller must remain within the acceptable voltage range of the portable power system.

However, during nighttime hours or periods of reduced solar availability, alternative energy sources are required. By way of example, a military vehicle may provide a 24-volt DC output. If the portable power system is configured to receive 48-volt DC power from a solar panel array, the 24-volt supply from the vehicle will be insufficient for charging. Furthermore, without appropriate electrical connectors, the vehicle output port cannot be directly coupled to the solar input port of the portable power storage system.

Accordingly, there is a need for a device that enables coupling between a vehicle output port and a solar panel input port of a portable power storage system, while converting the vehicle-supplied DC power to a voltage compatible with the system.

There is also a need for a device that can be operated in reverse, jump starting a vehicle.

The present invention is directed to addressing these needs and overcoming one or more of the deficiencies noted above.

### SUMMARY OF THE INVENTION

It is an object of the present invention to provide a device and method for coupling an external power source, such as a vehicle DC output port, to the solar panel input connection of a portable power storage system. Another object is to enable conversion of power from an external supply, which may have a lower or otherwise incompatible voltage, into a suitable charging voltage for the portable power storage system. A further object is to increase the versatility and operational reliability of portable power storage systems by allowing them to be charged from a wider range of DC supply sources without requiring modification of the internal charging circuitry.

In one aspect, the invention provides an adapter device comprising an electrical connector configured for coupling to a DC power output port of a vehicle or other external source, an electrical connector configured for coupling to a solar panel input port of a portable power storage system, and a power conversion circuit electrically coupled between the connectors. The power conversion circuit is configured to receive DC power from the vehicle output port and to supply a converted DC voltage suitable for input to the solar charging circuit of the portable power storage system.

In another aspect, the invention provides a method of charging a portable power storage system, including the steps of connecting a DC output port of a vehicle to a solar panel input port of the portable power storage system, converting the voltage of the DC power supplied from the vehicle output port to a level compatible with the solar panel input requirements of the portable power storage system, and delivering the converted power to the system through the solar panel input port.

The invention thereby enables portable power storage systems to be charged not only from solar panel arrays but also from external DC sources, such as military vehicles, utility vehicles, or other transportable power supplies, which may otherwise be electrically or mechanically incompatible. This increases operational flexibility and ensures that portable power storage systems may remain charged and functional in environments where solar input is unavailable or insufficient.

One exemplary embodiment of the invention is a converter for supplying power to a portable power storage system. This converter includes a housing that contains a DC-to-DC power converter circuit, which takes a lower DC voltage from a vehicle power outlet and boosts it to a higher DC voltage. This higher voltage is configured to be perceived by the power storage system as a supply from a solar panel array without any required modifications to the system itself. The converter has a first electrical connector that mates with the vehicle's power outlet and a second electrical connector that mates with the inlet of the power storage system. The first connector may be a NATO DC slave plug, while the second connector can be an MC4 or an Anderson Powerpole connector. The power converter circuit itself can be a boost converter and may be configured to raise a 24-volt input to an approximately 48-volt output. To manage heat, the housing may have external heat dissipation fins or an integrated fan for forced-air cooling. The circuit's output voltage is maintained by a controller that regulates the duty cycle of a switching element. The converter may also include a communication module, such as a Bluetooth or Wi-Fi module, to transmit operational data.

Another exemplary embodiment is a bidirectional converter designed to interface a vehicle's electrical system with a portable power storage system. This converter is housed within a casing and contains a bidirectional DC-to-DC power conversion stage and a controller. It features a first electrical connector for the vehicle power outlet and a second electrical connector for the power storage system's solar inlet. The controller enables the converter to operate in two distinct modes. In a first mode, it steps up the vehicle's voltage and provides a regulated output that mimics a solar panel array, allowing it to charge the power storage system. In a second mode, it steps down a voltage from the power storage system and provides a regulated output to the vehicle, which can be used to recharge the vehicle's battery or assist in engine starting. The controller can automatically sense voltages at both connectors and select the appropriate mode. The converter also includes at least one protection circuit, such as overcurrent, overvoltage, undervoltage, reverse-polarity protection, or thermal shutdown, to ensure safe operation.

Another exemplary embodiment is a complete system for charging a portable power storage system from a vehicle. This system includes a portable power storage unit that has an inlet designed to receive voltage from a solar panel array. This inlet is connected to a charging circuit and a rechargeable battery. The system also includes a converter with a housing that contains a DC-to-DC step-up converter. The converter's input is connected via a first electrical connector to a vehicle power outlet, and its output is connected to the storage system's inlet via a second electrical connector. This arrangement allows the step-up converter to transform a vehicle's supply voltage into a regulated output that emulates a solar panel array. This enables the power storage system's charging circuit to charge its battery directly from the vehicle. The first electrical connector can be a NATO DC slave plug, and the second can be an MC4 or an Anderson Powerpole connector. The DC-to-DC converter itself is a boost converter, which includes an inductor, a switching element, a diode, and an output capacitor. For example, it can transform a 24-volt vehicle supply into a regulated 48-volt output.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a plan view of an exemplary converter according to principles of the invention.

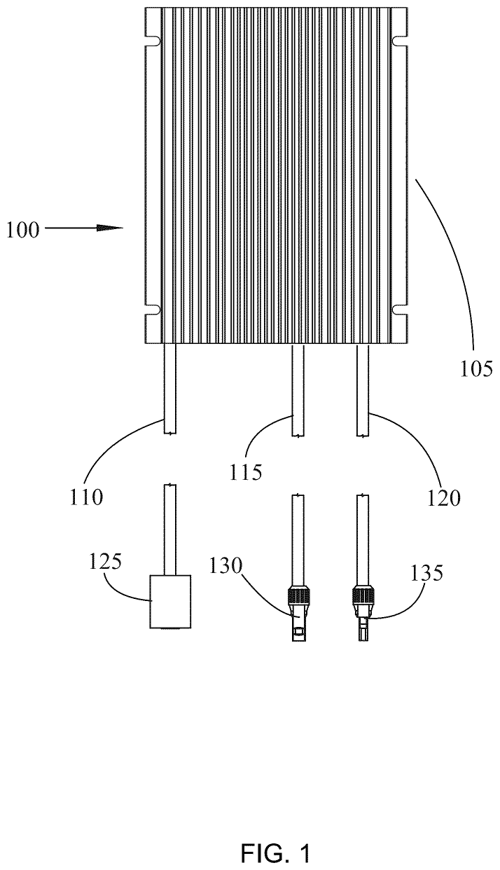

FIG. 2 is a perspective view of an exemplary converter according to principles of the invention.

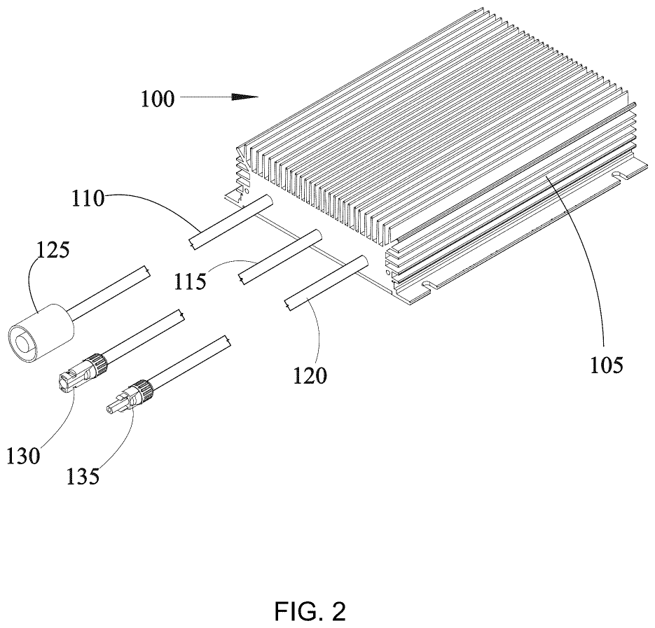

FIG. 3 is a perspective view of exemplary electric connectors for a converter according to principles of the invention.

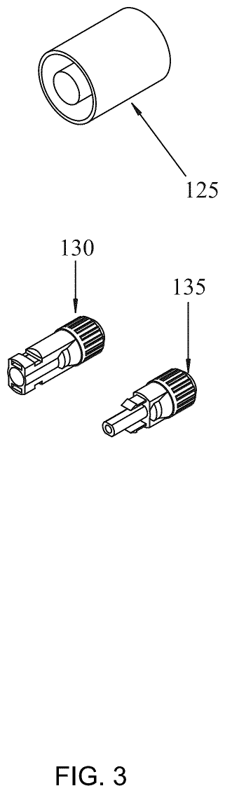

FIG. 4 is a high-level schematic of an exemplary step-up circuit for a converter according to principles of the invention.

FIG. 5 is a graphical representation of the P-V curve emulation of a solar array by the converter.

FIG. 6 is a block diagram of an exemplary bidirectional converter according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the specific components, configurations, shapes, relative sizes, ornamental aspects, or proportions as shown in the figures.

### DETAILED DESCRIPTION

A converter according to principles of the present invention provides a seamless interface between a portable electric power storage system and a vehicle electrical outlet or other external DC power source, allowing the storage system to be charged directly from the external source while perceiving the input as indistinguishable from that of a solar panel array. This functional emulation of the power-voltage characteristics of a solar panel array enables the power storage system to operate using its existing charging circuitry, such as a Maximum Power Point Tracking (MPPT) controller, without modification.

The power storage system is designed to receive energy from a power source such as a solar panel array, through an inlet configured to accept standardized connectors such as MC4 or Anderson connectors. Within the storage system is a charging circuit and a battery that may be lithium-ion, lithium-iron-phosphate, nickel-manganese-cobalt, or another rechargeable chemistry optimized for capacity and durability. A battery management subsystem may further regulate charging, discharge, and cell balancing. When connected to the converter 100, the storage system receives electrical power from a vehicle or other external source as though it were being supplied by a solar array, thereby maintaining normal operation.

The converter 100 is enclosed in a housing 105 that contains the power conversion circuit. The housing 105 may be fabricated from high-impact ABS plastic, aluminum, or composite polymers and may incorporate cooling fins for efficient passive heat dissipation. For higher power applications, the housing 105 may optionally include an internal fan. To withstand outdoor and military use, the housing 105 may be sealed against dust and moisture to achieve ingress protection ratings such as IP65 or IP67.

For connection to a vehicle or other external power source, the converter 100 employs a NATO DC Slave Plug 125. The plug 125 is typically cylindrical and formed from durable insulating material, such as high-impact plastic or metal alloy, and may be ergonomically contoured for secure handling. Within the plug 125 are two electrical contact pins, one carrying positive polarity (DC+) and the other negative (DC−). These pins may be copper, brass, or similar conductive metals, optionally plated with corrosion-resistant coatings such as nickel or gold to reduce resistance and extend service life. The central pin conveys positive voltage while the concentric surrounding pin conveys negative voltage, ensuring proper polarity alignment when the plug 125 is mated with a NATO vehicle receptacle. The plug 125 may include a protective dust cover and a strain-relieved cable 110 that connects to the power conversion circuit inside the housing 105. The cable 110 may be a heavy-gauge, multi-strand copper conductor capable of carrying high current, with flexible insulation to withstand rugged field handling.

The term NATO DC slave plug as used herein refers to a standardized direct current (DC) electrical connector employed by military vehicles and equipment for auxiliary starting, power distribution, and field interoperability. This connector typically conforms to NATO STANAG 4074 specifications and is designed for ruggedized, high-current applications requiring compatibility across multiple vehicle platforms. For purposes of this disclosure, the term NATO DC slave plug (240) may be understood more generally as a standardized high-current DC connector configured for auxiliary power connection between vehicles or external power supplies.

The converter 100 provides output through connectors that are compatible with the supply receptacles of the storage system. In an exemplary embodiment, the converter 100 employs a pair of MC4 connectors 130 and 135. These connectors 130, 135 are molded from UV-resistant plastic and incorporate locking latches that secure the connection to mating connectors on the storage system. Each MC4 connector 130, 135 contains a conductive contact pin, typically copper or tinned copper, which is crimped or soldered to the end of an output cable 115 or 120, ensuring low-resistance electrical contact. Waterproofing is provided by internal silicone O-rings, while strain relief features prevent damage at the cable entry points. Alternative embodiments may substitute Anderson Powerpole connectors, XT90 or XT60 connectors, or other robust DC power connectors in place of the MC4 connectors 130, 135, depending on system requirements.

The term Anderson Powerpole connector as used herein refers to a commercially available modular, genderless, polarized electrical connector system commonly employed for direct current (DC) power distribution in portable, vehicular, and emergency applications. These connectors are characterized by their mechanically keyed housings, flat-wiping contact surfaces, and the ability to be mated in multiple orientations to achieve standardized color-coded polarity. For purposes of this disclosure, the term Anderson Powerpole connector may be understood more generally as a modular DC power connector suitable for high-current, quick-disconnect applications.

The term XT90 connector as used herein refers to a high-current, polarized, bullet-style electrical connector. This connector is typically rated for currents up to approximately 90 amperes and is designed with molded housings that prevent reverse polarity mating. For purposes of this disclosure, the term XT90 connector may be understood more generally as a high-current polarized DC connector configured for secure, quick-disconnect applications.

The term XT60 connector as used herein refers to a polarized, bullet-style electrical connector similar in form to the XT90 but typically rated for moderate current levels up to approximately 60 amperes. For purposes of this disclosure, the term XT60 connector may be understood more generally as a medium-current polarized DC connector.

The term MC4 connector as used herein refers to a standardized single-contact, locking DC connector commonly employed in photovoltaic (PV) solar panel installations. These connectors are weatherproof, designed for outdoor use, and facilitate secure, tool-assisted mating to prevent accidental disconnection. MC4 connectors are typically used for interconnecting solar panels and connecting panels to power management equipment. For purposes of this disclosure, the term MC4 connector may be understood more generally as a locking weatherproof DC connector suitable for photovoltaic or outdoor applications.

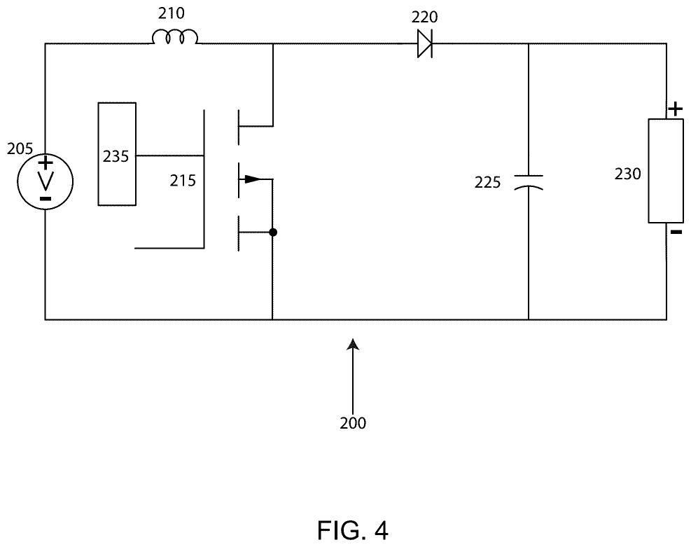

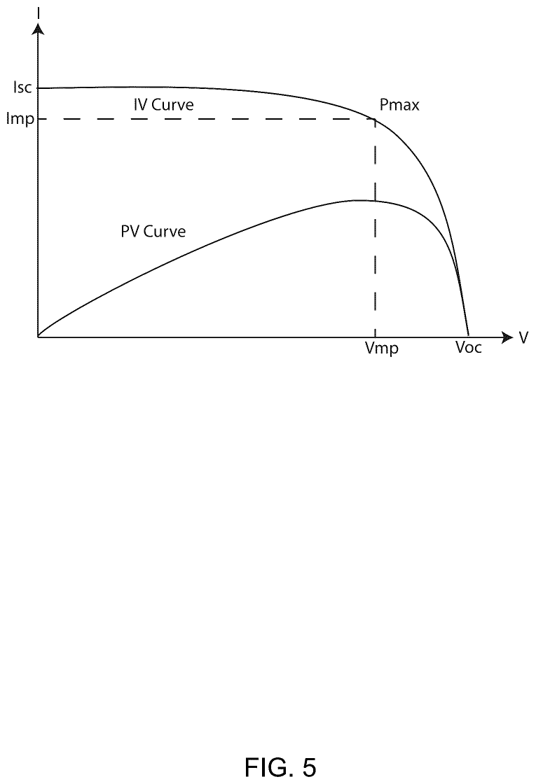

The operation of the converter 100 is best understood with reference to the schematic representation of FIG. 4. When the NATO DC Slave Plug 125 is connected to a NATO-standard vehicle outlet, the vehicle acts as a voltage source 205 delivering, for example, 24 V DC. This input is directed to an inductor 210, which stores energy in a magnetic field as current flows. A switch 215, such as a MOSFET transistor, is controlled by a controller 235 to alternately open and close the circuit. When the switch 215 is closed, current flows through the inductor 210, storing energy. When the switch 215 opens, the inductor 210 generates an induced voltage that combines with the input voltage, driving current through a diode 220 and charging a capacitor 225. The capacitor 225 smooths the output, providing a stable higher voltage to the load 230, which in this embodiment is represented by the pair of MC4 connectors 130 and 135 mated with the storage system's inlet. By adjusting the duty cycle of the switch 215, the controller 235 maintains a regulated output, stepping the 24 V vehicle input up to a 48 V output suitable for the storage system. As shown in FIG. 5, in one embodiment the controller 235 is further configured to provide a regulated output that mimics the IV curve of a solar array, ensuring the output current and voltage relationship is within the optimal operating range for an MPPT controller in the portable power storage system.

With reference to FIG. 5, the IV curve of a photovoltaic (PV) module is a graphical representation of the relationship between its current and voltage output under given sunlight (irradiance) and temperature conditions. It is obtained by measuring the current and voltage output of a module while varying the load. Some of the main parameters found from an IV curve include the open-circuit voltage (Voc), the short-circuit current (Isc), the maximum power point voltage (Vmpp), the maximum power point current (Impp), the maximum power (Pmax), and the fill factor (FF). The Voc is the maximum voltage that can be obtained from the module when there is no load connected, while the Isc is the maximum current that the module can produce when its output is shorted. Vmpp and Impp represent the combination of voltage and current that results in the highest power output (Pmax) from the module. The fill factor is a measure of how well the module performs and is calculated as the ratio of Pmax to the product of the Voc and Isc.

The sloping shape of the IV curve is due to physical processes that occur within the PV cells. In a PV cell, photons from the sun are absorbed by the semiconductor material, creating electron-hole pairs. The electric field within the cell separates the electron-hole pairs, creating a flow of current.

At low voltages, the current is limited by the resistance of the cell, but at higher voltages, the current output is limited by charge carrier recombination processes, which reduce the number of electron-hole pairs available to contribute to the current. This results in a decrease in the current output as voltage increases until it reaches zero at the open-circuit voltage (Voc).

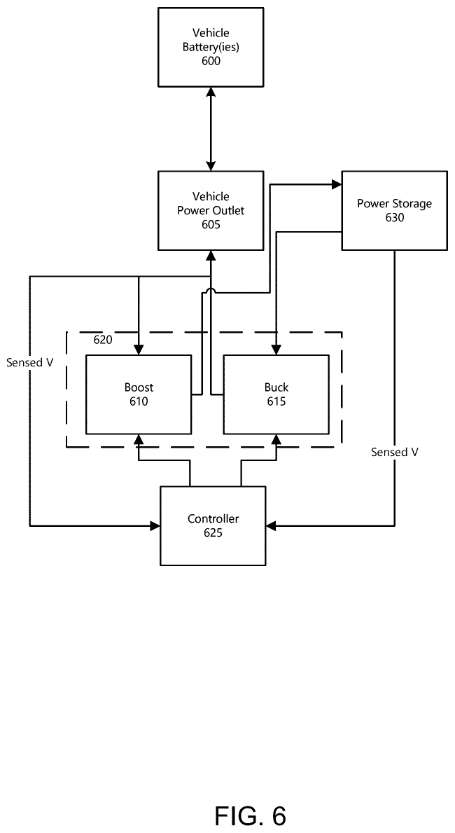

Although the embodiment illustrated employs a boost converter topology, alternative embodiments may use other DC-to-DC converter designs. A flyback converter may be substituted, employing a transformer to provide galvanic isolation between the vehicle and the storage system, thereby improving safety. A forward converter or half-bridge configuration may be used in higher-power systems to improve efficiency or reduce component size. In another embodiment, the converter 100 may be designed to be bidirectional, functioning not only to charge the storage system from the vehicle but also to allow power from the storage system to flow back through the converter 100 into the vehicle, enabling functions such as jump-starting. Such bidirectional capability may be achieved by employing power electronics that operate in both boost and buck modes, managed by a controller 235 capable of regulating bidirectional flow and automatically selecting the mode based on sensed voltages, as depicted in the block diagram of FIG. 6. The controller's logic includes monitoring the voltage at both the vehicle connector and the power storage system connector, and based on pre-defined voltage thresholds, it can autonomously switch from a charging (boost) mode to a discharging (buck) mode. For example, if the vehicle battery voltage drops below a certain threshold (e.g., 20V) and the portable power storage system is connected and above a healthy charge level, the controller may initiate the buck mode to provide power back to the vehicle.

The housing 105 may incorporate additional protective features such as fuses or circuit breakers to prevent overcurrent conditions. The controller 235 may include undervoltage, overvoltage, and thermal protections to safeguard both the converter 100 and the connected systems. Advanced embodiments may further include monitoring and communication functions, with Bluetooth, Wi-Fi, or CAN bus modules integrated into the housing 105, thereby allowing a user to remotely monitor charging voltage, current, temperature, and system health via a mobile device or a vehicle display system.

In operation, when the converter 100 is connected via NATO DC Slave Plug 125 to a vehicle and via MC4 connectors 130, 135 to a storage system, the storage system recognizes the incoming energy as though it were delivered from a solar panel array. The emulation of solar input, including the power-voltage characteristics, is a central inventive feature, permitting the storage system to operate seamlessly without modification. In alternative embodiments, the converter 100 may be configured to accept both vehicle power and solar panel input simultaneously, with the controller 235 executing maximum power point tracking to prioritize solar energy while supplementing with vehicle power as necessary. In larger capacity versions, multiple converter circuits may be integrated within the housing 105 in parallel, thereby delivering higher power suitable for charging larger storage banks.

The converter 100 thus represents a novel and nonobvious solution to the challenge of charging solar-optimized storage systems from vehicle power sources. By emulating the characteristics of a solar panel array at its output, the converter 100 allows portable power systems to operate transparently across both renewable and vehicle-based energy environments. The combination of ruggedized housing 105, military-grade NATO plug 125, universal connector outputs 130 and 135, efficient conversion circuitry comprising inductor 210, switch 215, diode 220, capacitor 225, and controller 235, and the option for bidirectional and intelligent communication features, produces a field-ready accessory uniquely suited to military, emergency response, and commercial applications.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A converter for supplying power to a portable power storage system, comprising:
a housing;
a DC-to-DC power converter circuit disposed within the housing, the circuit configured to receive a first DC input voltage from an external DC power source and to provide a second DC output voltage higher than the first DC input voltage;
a first electrical connector coupled to the DC-to-DC power converter circuit and configured to mate with the external DC power source; and
a second electrical connector coupled to the DC-to-DC power converter circuit and configured to mate with an inlet of the portable power storage system;
wherein the DC-to-DC power converter circuit is configured to provide the second DC output such that the portable power storage system perceives the second DC output as a supply from a solar panel array, wherein the converter is configured to output power at a regulated voltage and current, thereby emulating a photovoltaic array's power-voltage characteristics.

2. The converter of claim 1, wherein the first electrical connector comprises a NATO DC slave plug.

3. The converter of claim 1, wherein the second electrical connector comprises an MC4 connector.

4. The converter of claim 1, wherein the second electrical connector comprises an Anderson Powerpole connector.

5. The converter of claim 1, wherein the DC-to-DC power converter circuit comprises a boost converter.

6. The converter of claim 1, wherein the first DC input voltage is approximately twenty-four volts and the second DC output voltage is approximately forty-eight volts.

7. The converter of claim 1, wherein the housing comprises an external heat dissipation fin structure.

8. The converter of claim 1, wherein the housing comprises an integrated fan configured to provide forced-air cooling of the DC-to-DC power converter circuit.

9. The converter of claim 1, wherein the DC-to-DC power converter circuit includes a controller configured to regulate a duty cycle of a switching element to maintain the second DC output voltage and to emulate the photovoltaic array's power-voltage characteristics.

10. The converter of claim 1, further comprising a communication module disposed within the housing and configured to transmit data relating to operation of the converter.

11. The converter of claim 10, wherein the communication module comprises a Bluetooth module or a Wi-Fi module.

12. The converter of claim 1, wherein the DC-to-DC power converter circuit is a bidirectional DC-to-DC power conversion stage, and the converter further includes a controller operatively coupled to the bidirectional DC-to-DC power conversion stage and configured to operate in a first mode to step up the first DC input voltage to charge the portable power storage system and in a second mode to step down a voltage from the portable power storage system to provide a regulated output compatible with the external DC power source.

13. A bidirectional converter for interfacing a vehicle electrical system with a portable power storage system, comprising:
a housing;
a bidirectional DC-to-DC power conversion stage disposed within the housing;
a first electrical connector configured to mate with a vehicle power outlet;
a second electrical connector configured to mate with an inlet of the portable power storage system that is configured to receive power as if from a solar panel array; and
a controller operatively coupled to the bidirectional DC-to-DC power conversion stage;
wherein the controller is configured to sense voltages at the first electrical connector and the second electrical connector and to automatically select a first mode to step up a vehicle-supplied voltage and provide, at the second electrical connector, a regulated output that emulates a supply voltage from a solar panel array to charge the portable power storage system, or a second mode to step down a voltage from the portable power storage system and provide, at the first electrical connector, a regulated output compatible with the vehicle electrical system to recharge a vehicle battery and enable engine starting.

14. The bidirectional converter of claim 13, further comprising at least one protection circuit selected from the group consisting of overcurrent protection, overvoltage protection, undervoltage protection, reverse-polarity protection, inrush current limiting, and thermal shutdown.

15. A system for charging a portable power storage system from a vehicle, comprising:
a portable power storage system including an inlet configured to receive a supply voltage from a solar panel array, a charging circuit coupled to the inlet, and a rechargeable battery coupled to the charging circuit; and
a converter electrically coupled to the inlet of the portable power storage system, the converter comprising a housing, a DC-to-DC step-up converter disposed within the housing, a first electrical connector configured to mate with a vehicle power outlet and coupled to an input of the DC-to-DC step-up converter, and a second electrical connector configured to mate with the inlet of the portable power storage system and coupled to an output of the DC-to-DC step-up converter;
wherein the DC-to-DC step-up converter transforms a vehicle supply voltage into a regulated output voltage that emulates the supply voltage and power-voltage characteristics from the solar panel array, thereby enabling the charging circuit of the portable power storage system to charge the rechargeable battery from the vehicle.

16. The system of claim 15, wherein the first electrical connector comprises a NATO DC slave plug.

17. The system of claim 15, wherein the second electrical connector comprises an MC4 connector.

18. The system of claim 15, wherein the second electrical connector comprises an Anderson Powerpole connector.

19. The system of claim 15, wherein the DC-to-DC step-up converter comprises a boost converter including an inductor, a switching element, a diode, and an output capacitor.

20. The system of claim 15, wherein the vehicle supply voltage is approximately twenty-four volts and the regulated output voltage is approximately forty-eight volts.
